(19) United States
(12) Patent Application Publication
(10) Pub. No.: US 2025/0054104 A1
(43) Pub. Date: Feb. 13, 2025

(54) APPARATUS, METHOD, AND PROCESSOR FOR AUTONOMOUSLY MAKING IMAGE MODIFICATIONS

(71) Applicant: Lenovo (Singapore) Pte. Ltd., New Tech Park (SG)

(72) Inventors: John W. Nicholson, Cary, NC (US); Daryl C. Cromer, Raleigh, NC (US); Howard Locker, Cary, NC (US)

(21) Appl. No.: 18/366,267

(22) Filed: Aug. 7, 2023

(51) Int. Cl. G06T 5/50; H04N 23/60; H04N 23/661

(52) U.S. Cl. CPC G06T 5/50; H04N 23/64; H04N 23/661; G06T 2207/20081; G06T 2207/20212

(57) ABSTRACT

Apparatuses, methods, and program products are disclosed for autonomously making image modifications. One apparatus includes at least one memory and at least one processor coupled with the at least one memory and configured to cause the apparatus to receive first image data from a first camera. The at least one processor is further configured to cause the apparatus to determine a modification based at least partly on the first image data, second image data from a second camera, or a combination thereof. The at least one processor is also configured to cause the apparatus to initiate the modification based at least partly on the first image data, the second image data, or the combination thereof.

### FIELD

The subject matter disclosed herein relates to information handling devices and more particularly relates to autonomously making image modifications.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions, such as capturing image data. Image data from one camera may be incongruous with image data from another camera.

### BRIEF SUMMARY

An apparatus for autonomously making image modifications is disclosed. A method and processor also perform the functions of the apparatus. In one embodiment, the apparatus includes at least one memory and at least one processor coupled with the at least one memory and configured to cause the apparatus to: receive first image data from a first camera; determine a modification based at least partly on the first image data, second image data from a second camera, or a combination thereof; and initiate the modification based at least partly on the first image data, the second image data, or the combination thereof.

In some embodiments, the apparatus includes the first image data includes a first camera parameter. In one embodiment, the at least one processor is configured to cause the apparatus to determine the modification by determining a second camera parameter for the second camera based at least in part on the first camera parameter.

In various embodiments, the second camera parameter is configured to cause the second camera to produce a second image having a second image quality similar to a first image quality of a first image produced by the first camera. In some embodiments, the first camera parameter includes an ambient light level, ambient color temperature, a resolution, an aperture, a gain level, an exposure time or shutter speed, an exposure compensation, a field of view, a zoom level, or a combination thereof.

A method for autonomously making image modifications, in one embodiment, includes receiving, by use of at least one processor, first image data from a first camera. In certain embodiments, the method includes determining a modification based at least partly on the first image data, second image data from a second camera, or a combination thereof. In some embodiments, the method includes initiating the modification based at least partly on the first image data, the second image data, or the combination thereof.

In some embodiments, the first image data includes a first camera parameter. In various embodiments, determining the modification includes determining a second camera parameter for the second camera based at least in part on the first camera parameter. In one embodiment, the second camera parameter is configured to cause the second camera to produce a second image having a second image quality similar to a first image quality of a first image produced by the first camera. In some embodiments, initiating the modification includes transmitting the second camera parameter to the second camera. In certain embodiments, the first camera parameter includes an ambient light level, ambient color temperature, a resolution, an aperture, a gain level, an exposure time or shutter speed, an exposure compensation, a field of view, a zoom level, or a combination thereof.

In some embodiments, determining the modification includes using a trained model to determine the modification. In various embodiments, the modification is configured to cause a first image quality of the first camera to be similar to a second image quality of the second camera. In certain embodiments, determining the modification includes comparing a first image of the first camera to a second image of the second camera. In some embodiments, implementing the modification includes processing the first image, the second image, or a combination thereof to cause a first image quality of the first image to be similar to a second image quality of the second image. In various embodiments, the modification is performed by the at least one processor. In certain embodiments, the modification is performed by a remote system.

In one embodiment, a processor includes at least one controller coupled with at least one memory and configured to cause the processor to: receive first image data from a first camera; determine a modification based at least partly on the first image data, second image data from a second camera, or a combination thereof; and initiate the modification based at least partly on the first image data, the second image data, or the combination thereof.

In certain embodiments, the first image data includes a first camera parameter. In one embodiment, the first camera parameter includes an ambient light level, ambient color temperature, a resolution, an aperture, a gain level, an exposure time or shutter speed, an exposure compensation, a field of view, a zoom level, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for autonomously making image modifications;

FIG. 2 is a schematic block diagram illustrating one embodiment of an apparatus including an information handling device;

FIG. 3 is a schematic block diagram illustrating one embodiment of an apparatus including an image quality control module;

FIG. 4 is a schematic block diagram illustrating one embodiment of a system that uses an image quality control module;

FIG. 5 is a schematic block diagram illustrating one embodiment of displays using an image quality control module; and

FIG. 6 is a schematic flow chart diagram illustrating an embodiment of a method for autonomously making image modifications.

### DETAILED DESCRIPTION

As will be appreciated by one skilled in the art, aspects of the embodiments may be embodied as a system, apparatus, method, processor, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be used. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, processors, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to one or more processors of a general purpose computer, special purpose computer, or other programmable data processing apparatus to produce a machine, such that the instructions, which execute via the one or more processors of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

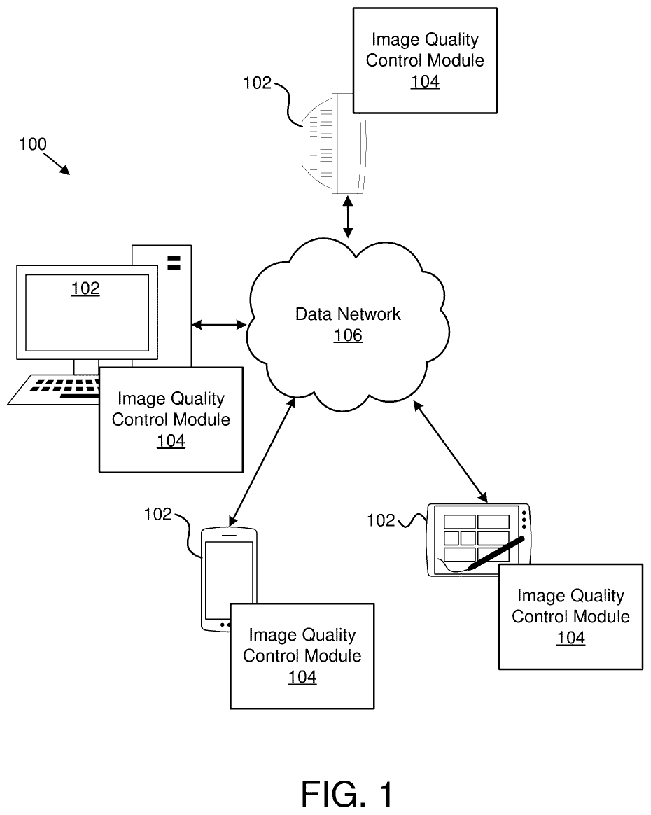

FIG. 1 depicts one embodiment of a system 100 for autonomously making image modifications. In one embodiment, the system 100 includes information handling devices 102, image quality control modules 104, and data networks 106. Even though a specific number of information handling devices 102, image quality control modules 104, and data networks 106 are depicted in FIG. 1, one of skill in the art will recognize that any number of information handling devices 102, image quality control modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, digital assistants (e.g., public digital assistants), or the like that may include one or more image capturing devices (e.g., video cameras, cameras). In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the image quality control module 104. In certain embodiments, the image quality control module 104 may receive, by use of at least one processor, first image data from a first camera. The image quality control module 104 may also determine a modification based at least partly on the first image data, second image data from a second camera, or a combination thereof. The image quality control module 104 may initiate the modification based at least partly on the first image data, the second image data, or the combination thereof. In this manner, the image quality control module 104 may be used for autonomously making image modifications.

The data network 106, in one embodiment, includes a digital communication network that transmits digital communications. The data network 106 may include a wireless network, such as a wireless cellular network, a local wireless network, such as a Wi-Fi network, a Bluetooth® network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

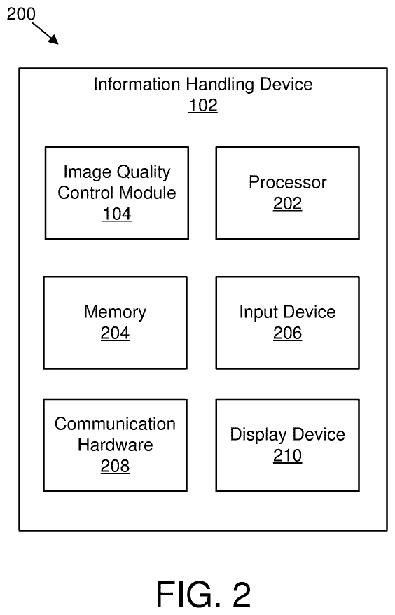

FIG. 2 depicts one embodiment of an apparatus 200 that may be used for autonomously making image modifications. The apparatus 200 includes one embodiment of the information handling device 102. Furthermore, the information handling device 102 may include the image quality control module 104, a processor 202, a memory 204, an input device 206, communication hardware 208, and optionally a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the image quality control module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores configuration information. In some embodiments, the memory 204 also stores program code and related data, such as an operating system or other controller algorithms operating on the information handling device 102.

The information handling device 102 may use the image quality control module 104 for autonomously making image modifications. As may be appreciated, the image quality control module 104 may include computer hardware, computer software, or a combination of both computer hardware and computer software. For example, the image quality control module 104 may include circuitry, or the processor 202, used to receive first image data from a first camera. As another example, the image quality control module 104 may include computer program code that determines a modification based at least partly on the first image data, second image data from a second camera, or a combination thereof. As a further example, the image quality control module 104 may include computer program code that initiates the modification based at least partly on the first image data, the second image data, or the combination thereof.

The input device 206, in one embodiment, may include any known computer input device including a touch panel, a button, a keyboard, a stylus, a microphone for receiving audio input (e.g., or another audio input device for receiving audio input), an image capturing device, a camera, a video camera, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the image quality control module 104.

In various embodiments, such as in a hybrid work environment, having multiple cameras available for a meeting is an increasingly common situation. These cameras may be integrated with a laptop, one or more monitors, an external webcam, a phone, a dedicated device, and so forth.

In certain embodiments, a user may use a single camera for a meeting, and not switch between cameras. However, if multiple cameras are used together, an active camera might switch based on a user gaze and/or head pose.

In various embodiments, cameras in a multi-camera environment may be quite different from one another (e.g., come from different sources, different vendors, different tuning goals, have different resolutions, and so forth), and there may be image quality differences between the different cameras that may be visually obvious. For example, the same person might look noticeably different when switching between different cameras. Specifically, the difference in camera resolution or smoothing parameters might cause a significant difference in available details and texture. In another example, a difference in auto white-balancing (AWB) tuning and other parameters may lead to very different colors in a rendered image, which may be particularly noticeable or objectionable for various skin tones.

In some embodiments, a user of an information handling device 102 may desire to modify the image quality of a first camera image to be more similar to the image quality of a second camera image. Described herein are various embodiments that use an image quality control module 104 to autonomously make image modifications.

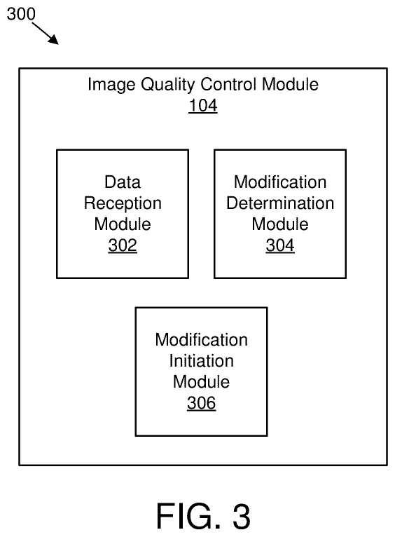

FIG. 3 depicts a schematic block diagram illustrating one embodiment of an apparatus 300 (e.g., information handling device 102) that includes one embodiment of the image quality control module 104. Furthermore, the image quality control module 104 includes a data reception module 302, a modification determination module 304, and a modification initiation module 306. The image quality control module 104 may be used to make the camera image quality between different cameras more similar by sharing some of the parameters that are used and/or determined.

In certain embodiments, a camera may estimate color temperature of an ambient lighting of a scene to correctly render colors. This estimation process is called auto white balancing (AWB). If two cameras arrive at a different estimate for a white balance point, the rendered image will look different. The different images may be made more similar by sharing values between the two cameras. In another embodiment, an exposure time of a camera may be set by an auto-exposure algorithm based on an estimate of an ambient light level (or lux level). The ambient light level estimate may be shared between camera modules so that a compatible exposure value may be used. In a further embodiment, smoothing algorithms may be employed by two cameras. Parameters controlling an amount of smoothing may be shared or adjusted to achieve similar and/or compatible levels.

In some embodiments, due to differences in hardware or other factors, multiple values might need to be shared between cameras (and/or camera controllers), including factors such as an estimate of an ambient condition (e.g., lux level). For example, with equation

$$L = \frac{{Kf}^{2}}{tS} ,$$

L is a lux level, K is a calibration constant, f is an aperture or f-number, t is an exposure time, and S is a film speed (or equivalent). Since the aperture may be (and frequently is) fixed, it may be necessary to share multiple values.

In certain embodiments, the data reception module 302 may receive, by use of at least one processor, first image data from a first camera. The first image data may include a first camera parameter (e.g., setting, configuration, quality). For example, the first camera parameter may include an ambient light level, ambient color temperature, a resolution, an aperture, a gain level, an exposure time or shutter speed, an exposure compensation, a field of view, a zoom level, or a combination thereof. It should be noted that the image quality control module 104, the data reception module 302, the modification determination module 304, and/or the modification initiation module 306 may be part of a camera software, a camera management software, an operating system, a server software, a cloud software, a video conferencing software, a video editing software, a data processing software, an image processing software, a camera hardware, and so forth.

In one embodiment, the modification determination module 304 may determine a modification to be made based at least partly on the first image data, second image data from a second camera, or a combination thereof. The second image data may be a type of data similar to the types of data of the first image data as described herein. Moreover, determining the modification may include determining a second camera parameter for the second camera based at least in part on the first camera parameter. In some embodiments, the second camera parameter is configured to cause the second camera to produce a second image having a second image quality similar to a first image quality of a first image produced by the first camera. For example, the determined modification may be a determined parameter setting for the second camera so that an image from the second camera has a quality similar to an image from the first camera. In various embodiments, initiating the modification includes transmitting the second camera parameter to the second camera.

In one embodiment, the image quality control module 104 may perform a machine learning approach to train a model (e.g., a style transfer network, a color filter) to process output of one camera so that it looks like another. In such an embodiment, there may be a registration process to collect data to train the model, or a separate process that collects usage data (e.g., in the background). The model may be particular to the particular combination of cameras (e.g., the particular combination of cameras may typically be in the same location). As may be appreciated, cameras may be trained to all look the same and/or one camera may act as a baseline and the other cameras may be trained to be like the baseline camera. In some embodiments, a system may detect significant deviations from training data and suggest (or automatically perform) a retraining procedure. In various embodiments, determining a modification includes using a trained model to determine the modification. Moreover, the modification may be configured to cause a first image quality of a first camera to be similar to a second image quality of a second camera.

In certain embodiments, an automatic image-registration may be able to determine which foreground and background items are the same in two camera views. With a system knowing that multiple cameras are looking at the same thing, post-processing can be adjusted such that the common items from one camera (e.g., stream B) are made to look like those of another camera (e.g., stream A).

In some embodiments, camera streams may look noticeably different because of different resolutions, either from the camera sensor itself or after framing (e.g., digital window, cropping). In such embodiments, the images can be made more similar by several means, such as: lowering the resolution of a better camera to match the quality of a lower-resolution camera; using details from a higher-resolution camera to up sample a lower-resolution image by appropriately transforming a perspective to that of the lower-resolution camera; and/or using a super-resolution or other deep-learning model on the lower-resolution image. It should be noted that post-processing may be performed locally (e.g., on the same system where the cameras are attached) or remotely (e.g., as in a relay server, or as in at each system where the camera stream is received). In certain embodiments, determining the modification includes comparing a first image of a first camera to a second image of a second camera.

In various embodiments, the modification initiation module 306 may initiate the modification based at least partly on the first image data, the second image data, or the combination thereof. In certain embodiments, implementing the modification includes processing the first image, the second image, or a combination thereof to cause a first image quality of the first image to be similar to a second image quality of the second image. In some embodiments, the modification is performed by at least one processor. In other embodiments, the modification is performed by a remote system.

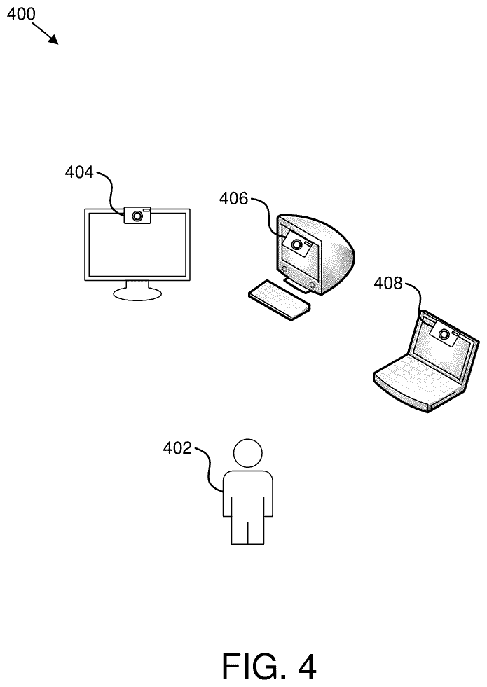

FIG. 4 is a schematic block diagram illustrating one embodiment of a system 400 that uses an image quality control module 102. The system 400 is used by a user 402 and includes multiple cameras 404, 406, and 408. As described herein, the image quality control module 102 coordinates between the multiple cameras 404, 406, and 408 to produce images having a similar quality.

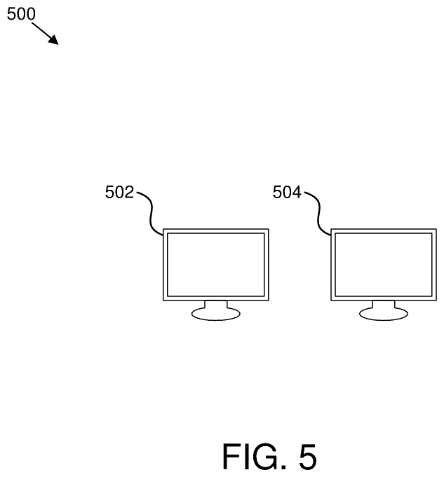

FIG. 5 is a schematic block diagram illustrating one embodiment of displays 500 using an image quality control module 102. In this example, without using the image quality control module 102, a first image from a first camera may be displayed on a first display 502 and a second image from a second camera may be displayed on a second display 504. The first image and the second image may not have a similar quality. In contrast, by using the image quality control module 102, a first image from a first camera may be displayed on a first display 502 and a second image from a second camera may be displayed on a second display 504. The first image and the second image may have a similar quality.

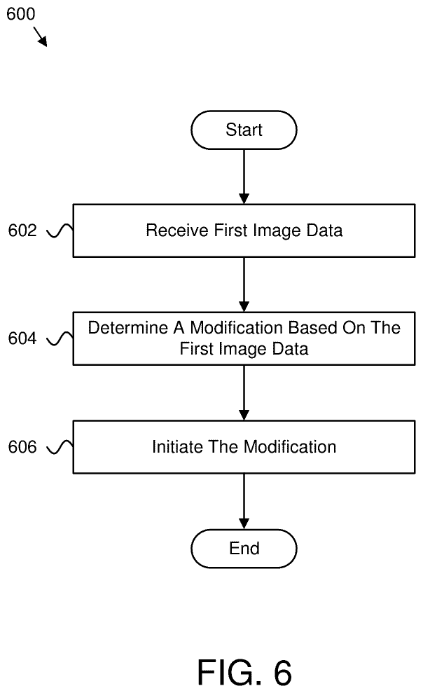

FIG. 6 is a schematic flow chart diagram illustrating an embodiment of a method 600 for autonomously making image modifications. In some embodiments, the method 600 is performed by an apparatus, such as the information handling device 102. In other embodiments, the method 600 may be performed by a module, such as the image quality control module 104. In certain embodiments, the method 600 may be performed by a processor executing program code, for example, a microcontroller, a microprocessor, a CPU, a GPU, an auxiliary processing unit, a FPGA, or the like.

The method 600 may include receiving 602, by use of at least one processor, first image data from a first camera. In certain embodiments, the data reception module 302 may receive 602 the first image data from the first camera. The method 600 may include determining 604 a modification based at least partly on the first image data, second image data from a second camera, or a combination thereof. In some embodiments, the modification determination module 304 may determine 604 the modification based at least partly on the first image data, the second image data from the second camera, or the combination thereof.

The method 600 may include initiating 606 the modification based at least partly on the first image data, the second image data, or the combination thereof. In some embodiments, the modification initiation module 306 may initiate 606 the modification based at least partly on the first image data, the second image data, or the combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
at least one memory; and
at least one processor coupled with the at least one memory and configured to cause the apparatus to:
receive first image data from a first camera;
determine a modification based at least partly on the first image data, second image data from a second camera, or a combination thereof; and
initiate the modification based at least partly on the first image data, the second image data, or the combination thereof.

2. The apparatus of claim 1, wherein the first image data comprises a first camera parameter.

3. The apparatus of claim 2, wherein the at least one processor is configured to cause the apparatus to determine the modification by determining a second camera parameter for the second camera based at least in part on the first camera parameter.

4. The apparatus of claim 3, wherein the second camera parameter is configured to cause the second camera to produce a second image having a second image quality similar to a first image quality of a first image produced by the first camera.

5. The apparatus of claim 2, wherein the first camera parameter comprises an ambient light level, ambient color temperature, a resolution, an aperture, a gain level, an exposure time or shutter speed, an exposure compensation, a field of view, a zoom level, or a combination thereof.

6. A method comprising:
receiving, by use of at least one processor, first image data from a first camera;
determining a modification based at least partly on the first image data, second image data from a second camera, or a combination thereof; and
initiating the modification based at least partly on the first image data, the second image data, or the combination thereof.

7. The method of claim 6, wherein the first image data comprises a first camera parameter.

8. The method of claim 7, wherein determining the modification comprises determining a second camera parameter for the second camera based at least in part on the first camera parameter.

9. The method of claim 8, wherein the second camera parameter is configured to cause the second camera to produce a second image having a second image quality similar to a first image quality of a first image produced by the first camera.

10. The method of claim 9, wherein initiating the modification comprises transmitting the second camera parameter to the second camera.

11. The method of claim 7, wherein the first camera parameter comprises an ambient light level, ambient color temperature, a resolution, an aperture, a gain level, an exposure time or shutter speed, an exposure compensation, a field of view, a zoom level, or a combination thereof.

12. The method of claim 6, wherein determining the modification comprises using a trained model to determine the modification.

13. The method of claim 6, wherein the modification is configured to cause a first image quality of the first camera to be similar to a second image quality of the second camera.

14. The method of claim 6, wherein determining the modification comprises comparing a first image of the first camera to a second image of the second camera.

15. The method of claim 14, wherein implementing the modification comprises processing the first image, the second image, or a combination thereof to cause a first image quality of the first image to be similar to a second image quality of the second image.

16. The method of claim 6, wherein the modification is performed by the at least one processor.

17. The method of claim 6, wherein the modification is performed by a remote system.

18. A processor, comprising:
at least one controller coupled with at least one memory and configured to cause the processor to:
receive first image data from a first camera;
determine a modification based at least partly on the first image data, second image data from a second camera, or a combination thereof; and
initiate the modification based at least partly on the first image data, the second image data, or the combination thereof.

19. The processor of claim 18, wherein the first image data comprises a first camera parameter.

20. The processor of claim 19, wherein the first camera parameter comprises an ambient light level, ambient color temperature, a resolution, an aperture, a gain level, an exposure time or shutter speed, an exposure compensation, a field of view, a zoom level, or a combination thereof.
